(19) United States
(12) Patent Application Publication
(10) Pub. No.: US 2026/0080406 A1
(43) Pub. Date: Mar. 19, 2026

(54) ENCODING SYSTEM FACILITATING PROTECTION OF DATA FROM MALICIOUS ACCESS BY SECURITY, ACCESS CONTROL, AND AUTHENTICATION

(71) Applicant: Truist Bank, Charlotte, NC (US)

(72) Inventor: Saloni Uboweja, Cary, NC (US)

(73) Assignee: Truist Bank, Charlotte, NC (US)

(21) Appl. No.: 18/884,725

(22) Filed: Sep. 13, 2024

(51) Int. Cl. G06Q 20/40; G06Q 20/32

(52) U.S. Cl. CPC G06Q 20/4014; G06Q 20/3274; G06Q 20/3278

(57) ABSTRACT

Systems receive a request to initiate production of an instrument having secure access control and specific to a user. Data associated with the instrument and the user are encoded as part of a scannable image, where the data are associated with partially populating a digital data submission form. Production and distribution of the instrument and the scannable image are initiated. It is ascertained that the scannable image has been scanned by an image sensor of an optical instrument and based thereon a version of the digital data submission form that is partially populated with user data associated with the user and instrument data associated with the instrument is transmitted, the version of the digital data submission form including input element(s). Input(s) for each of the input elements are received and verified. Activation of the instrument is authenticated for future use.

### FIELD OF THE INVENTION

This invention relates generally to the field of data encoding, and more particularly embodiments of the invention relate to an encoding system facilitating data security, access control, and authentication.

### BACKGROUND

Data encoding systems are often used to ensure that information can be accurately and securely transmitted through various systems. Various encoding schemes allow for interpretation and manipulation of information in an accurate manner while protecting sensitive information. Data encoding can reduce the likelihood that certain information is intercepted by bad actors as the data is not readily understood. However, existing data encoding systems can be cumbersome and may not be user friendly in various authentication contexts. Thus, a need exists for improved encoding systems for facilitating authentication using data encoding.

### SUMMARY

Shortcomings of the prior art are overcome and additional advantages are provided through the provision of a computing system for data security and authentication through encoding that includes at least one processor, a communication interface communicatively coupled to the at least one processor, and a memory device storing executable code that, when executed, causes the at least one processor to, at least in part, receive a request to initiate production of an instrument having secure access control, the instrument being specific to a user, and based thereon encode data associated with the instrument and the user as part of a scannable image to provide the access control of the instrument, wherein the data encoded as part of the scannable image are associated with partially populating a digital data submission form. Production and distribution of the instrument and the scannable image are initiated. Further, the system ascertains that the scannable image has been scanned by an image sensor of an optical instrument and based thereon transmit a version of the digital data submission form that is partially populated with user data associated with the user and instrument data associated with the instrument, the version of the digital data submission form including one or more input elements. One or more inputs are received for each of the input elements, and the system verifies that each of the one or more inputs correspond to the user data of the user. Based on the one or more inputs corresponding to the user data, the system authenticates activation of the instrument for future use.

Additionally, disclosed herein is a computer-implemented method that includes, at least in part, receiving a request to initiate production of an instrument having secure access control, the instrument being specific to a user, and based thereon encoding data associated with the instrument and the user as part of a scannable image to provide the access control of the instrument, wherein the data encoded as part of the scannable image are associated with partially populating a digital data submission form. The method also includes initiating production and distribution of the instrument and the scannable image, and ascertaining that the scannable image has been scanned by an image sensor of an optical instrument and based thereon transmitting a version of the digital data submission form that is partially populated with user data associated with the user and instrument data associated with the instrument, the version of the digital data submission form including one or more input elements. The method also includes receiving one or more inputs for each of the input elements and verifying that each of the one or more inputs correspond to the user data of the user. Based on the one or more inputs corresponding to the user data, the method also includes authenticating activation of the instrument for future use.

Also disclosed herein, is a computing system that includes at least one processor, a communication interface communicatively coupled to the at least one processor, and a memory device storing executable code that, when executed, causes the at least one processor to, at least in part, scan, via an image sensor of an optical instrument, a scannable image and based thereon detect modules within the scannable image, the modules encoding data associated with a user and an instrument. The computing system then displays, via a user interface, a partially populated digital submission form incorporating the data associated with the user and the instrument, wherein the partially populated digital submission form includes one or more input elements. One or more inputs are received for each of the one or more input elements. A completed digital submission form is transmitted for verification to facilitate activation of the instrument.

The features, functions, and advantages that have been described herein may be achieved independently in various embodiments of the present invention including computer-implemented methods, computer program products, and computing systems or may be combined in yet other embodiments, further details of which can be seen with reference to the following description and drawings.

### BRIEF DESCRIPTION

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

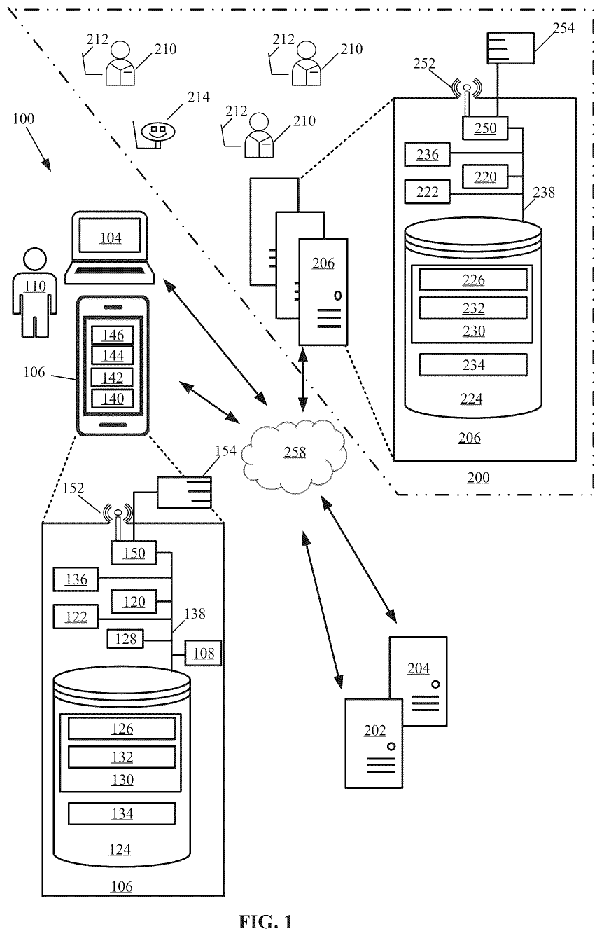

FIG. 1 depicts an example computer system configured to perform various processes described herein, according to an embodiment of the present invention;

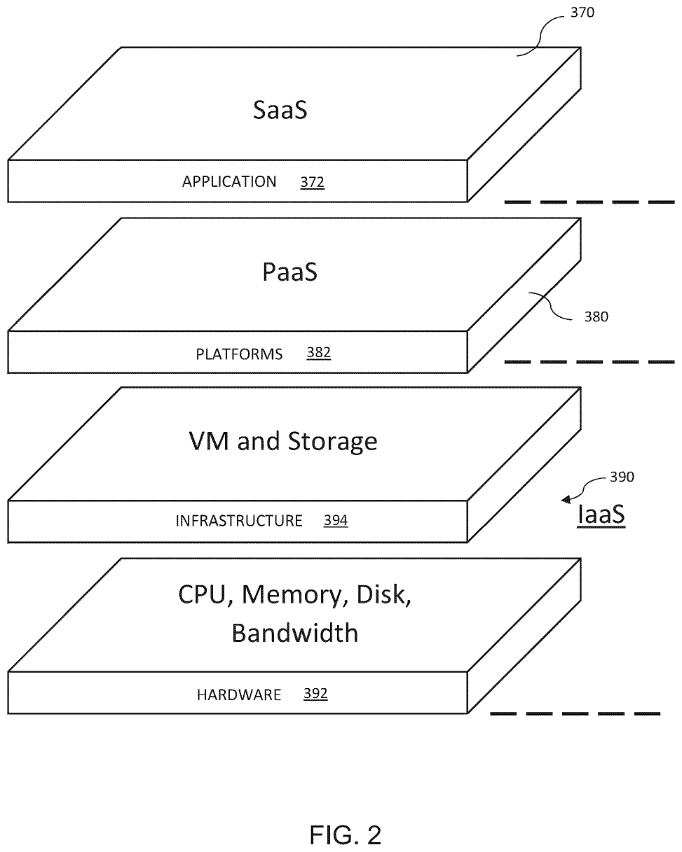

FIG. 2 depicts an example of cloud computing layers, according to an embodiment of the present invention;

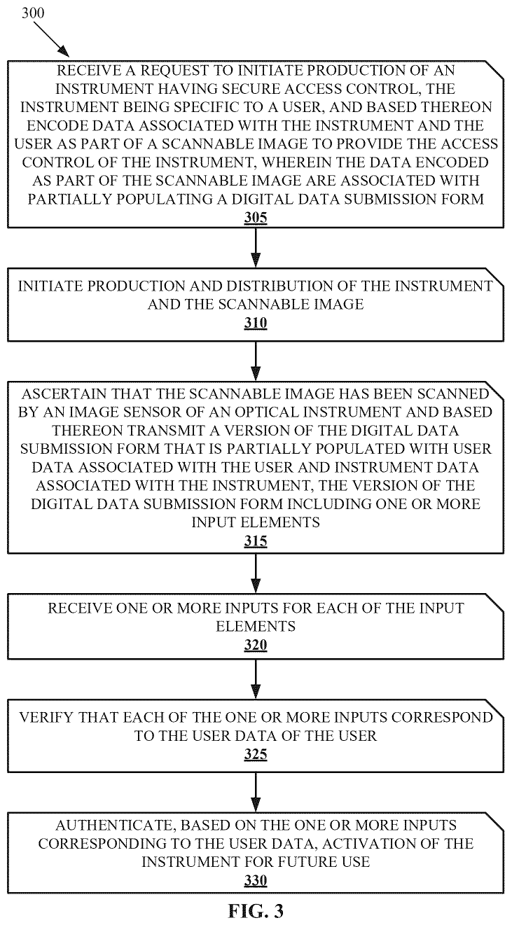

FIG. 3 depicts a block diagram of an example method, in accordance with an embodiment of the present invention; and

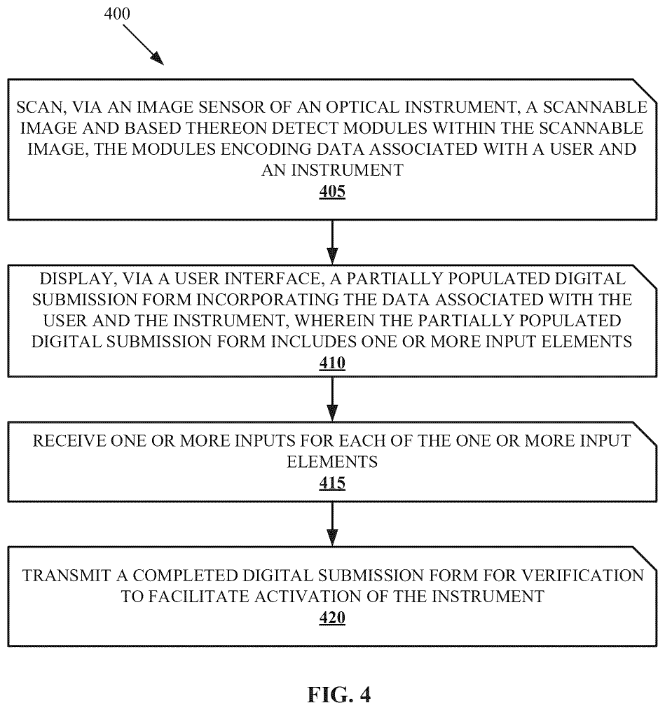

FIG. 4 depicts a block diagram of an example method, in accordance with an embodiment of the present invention.

### DETAILED DESCRIPTION

Aspects of the present invention and certain features, advantages, and details thereof are explained more fully below with reference to the non-limiting examples illustrated in the accompanying drawings. It is to be understood that the disclosed embodiments are merely illustrative of the present invention and the invention may take various forms. Further, the figures are not necessarily drawn to scale, as some features may be exaggerated to show details of particular components. Thus, specific structural and functional details illustrated herein are not to be interpreted as limiting, but merely as a representative basis for teaching one skilled in the art to employ the present invention.

Unless described or implied as exclusive alternatives, features throughout the drawings and descriptions should be taken as cumulative, such that features expressly associated with some particular embodiments can be combined with other embodiments.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

Like numbers refer to like elements throughout. Unless defined otherwise, technical and scientific terms used herein have the same meaning as commonly understood to one of ordinary skill in the art to which the presently disclosed subject matter pertains.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code, as referred to in this application, can include both software and hardware. For example, program code in certain embodiments of the present invention can include fixed function hardware, while other embodiments can utilize a software-based implementation of the functionality described. Certain embodiments combine both types of program code.

The specification may include references to “one embodiment,” “an embodiment,” “various embodiments,” “one or more embodiments,” etc. may indicate that the embodiment(s) described may include a particular feature, structure or characteristic, but every embodiment may not necessarily include the particular feature, structure, or characteristic. In some cases, such phrases are not necessarily referencing the same embodiment. When a particular feature, structure, or characteristic is described in connection with an embodiment, such description can be combined with features, structures, or characteristics described in connection with other embodiments, regardless of whether such combinations are explicitly described. Furthermore, a device or structure that is configured in a certain way is configured in at least that way, but may also be configured in ways that are not listed.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method, step of a method, device or element of a device that “comprises,” “has,” “includes,” or “contains,” or uses similar language to describe one or more steps or elements possesses those one or more steps or elements, but is not limited to possessing only those one or more steps or elements.

The terms “couple,” “coupled,” “connected,” and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. “Communicatively coupled to” and “operatively coupled to” can refer to physically and/or electrically related components.

In addition, as used herein, the terms “about,” “approximately,” or “substantially” for any numerical values or ranges indicate a suitable dimensional tolerance that allows the device, part, or collection of components to function for its intended purpose as described herein.

As used herein, the terms “enterprise” or “provider” generally describes a person or business enterprise (e.g., company, organization, institution, business, university, etc.) that hosts, maintains, or uses computer systems that provide functionality for the disclosed systems and methods. The term “enterprise” may generally describe a person or business enterprise providing goods and/or services. Interactions between an enterprise system and a user device can be implemented as an interaction between a computing system of the enterprise and a user device of a user. For instance, user(s) may provide various inputs that can be interpreted and analyzed using processing systems of the user device and/or processing systems of the enterprise system. Further, the enterprise computing system and the user device may be in communication via a network. According to various embodiments, the enterprise system and/or user device(s) may also be in communication with an external or third-party server of a third party system that may be used to perform one or more server operations. In some embodiments, the functions of one illustrated system or server may be provided by multiple systems, servers, or computing devices, including those physically located at a central computer processing facility and/or those physically located at remote locations.

Embodiments of the present invention are described herein with reference to flowchart illustrations and/or block diagrams of computer-implemented method(s) and computing system(s). Each block or combinations of blocks of the flowchart illustrations and/or block diagrams can be implemented by computer readable program instructions or code that may be provided to a processor of a general purpose computer, special purpose computer, programmable data processing apparatus or apparatuses (the term “apparatus” includes systems and computer program products), and/or other device(s). In particular, the computer readable program instructions, which can be executed via the processor of the computer, programmable data processing apparatus, and/or other device(s), create a means for implementing the functions/acts specified in the flowchart and/or block diagram block(s).

In one embodiment, computer readable program instructions may also be stored in one or more computer-readable storage media that can direct a computer, programmable data processing apparatus, and/or other device(s) to function in a particular manner such that a computer readable storage medium of the one or more computer-readable storage media having instructions stored therein comprises an article of manufacture that includes the computer readable program instructions, which implement aspects of the actions specified in the flowchart illustrations and/or block diagrams. In particular, the computer-readable program instructions may be used to produce a computer-implemented method by executing the instructions to implement the actions specified in the flowchart illustrations and/or block diagram block(s). Additionally or alternatively, these computer program instructions may be stored in a computer-readable memory that can direct a computer, programmable data processing apparatus, and/or other device(s) to function in a particular manner such that the instructions stored in the computer readable memory produce an article of manufacture that includes the computer readable program instructions, which implement the function/act specified in the flowchart and/or block diagram block(s). In some embodiments, computer-implemented steps/acts may be performed in combination with operator/human implemented steps/acts in order to carry out an embodiment of the invention.

In the flowchart illustrations and/or block diagrams disclosed herein, each block in the flowchart/diagrams may represent a module, segment, a specific instruction/function or portion of instructions/functions, and incorporates one or more executable computer readable program instructions for implementing the specified logical function(s). Similarly, alternative implementations and processes may also incorporate various blocks of the flowcharts and block diagrams. For instance, in some implementations the functions noted in the blocks may occur out of the order noted in the figures. For example, two blocks shown in succession may be executed substantially concurrently, and/or the functions of the blocks may sometimes be executed in the reverse order, depending upon the functionality involved.

FIG. 1 illustrates a system 100 and environment thereof, according to at least one embodiment, by which a user 110 benefits through use of services and products of an enterprise system 200. The environment may include, for example, a distributed cloud computing environment (private cloud, public cloud, community cloud, and/or hybrid cloud), an on-premise environment, fog-computing environment, and/or an edge-computing environment. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a global positioning service (GPS) device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

A cloud computing environment is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. Processes described herein may be performed singly or collectively by one or more computer systems.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user, required, or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). Also, the input and output system 136 may include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a GPS configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210 can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (SaaS). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, user devices, business entity devices, banking system devices, government entity devices, third-party PaaS, third-party IaaS, and external databases, are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes. According to various embodiments, external systems 202 and 204 may utilize software applications that function using external resources that are available through a third-party provider such as SaaS, PaaS, or IaaS service models. Such external systems 202, 204 include the third party systems accessible via the agent devices 212 using a software application (e.g., an integrated mobile software application or an application programming interface (API) software application) that can be integrated with the computing system 206 to facilitate communication between software and systems and also configured to utilize different data formats between systems. In another embodiment, the third party system may be accessible by the agent devices 212 using a web-based software interface (e.g., a website).

In certain embodiments, one or more of the systems such as the user device (referring to either or both of the computing device 104 and the mobile device 106), the enterprise system 200, and/or the external systems 202 and 204 are, include, or utilize virtual resources. In some cases, such virtual resources are considered cloud resources or virtual machines. The cloud computing configuration may provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

FIG. 2 depicts an example of cloud computing services, according to an embodiment of the present invention. The cloud computing services may be utilized by a cloud computing environment and may include a Software-as-a-Service (SaaS) 370, a Platform as a Service (PaaS) 380, and/or an Infrastructure as a Service (IaaS) 390. The cloud computing services offer infrastructure, platforms, and/or applications/software as services to and end-user so that the end-user does not need to maintain resources on a local computing device.

The SaaS service 370 may provide an end-user with the ability to use the provider's applications that are accessible and operable via cloud infrastructure. Specifically, the provider's applications layer 372 may be accessible via various network devices that include computer systems (e.g., computer system 100) via, for example, a thin client interface such as a web browser. With the SaaS model, the end-user is not authorized to manage or control the underlying cloud infrastructure, network, servers, operating systems, storage, or individual application capabilities offered by the provider, with the exception of limited user-specific application configuration settings.

The PaaS service 380 may provide the end-user with the ability to deploy consumer-created or acquired applications onto the cloud infrastructure using a platform layer 382, where the consumer-created applications may be created using programming languages and tools supported by the provider. Specifically, the end-user is not authorized to manage or control the underlying cloud infrastructure including networks, servers, operating systems, or storage. However, the end-user is authorized to control the deployed applications and possibly application hosting environment configurations available via the platform layer 382.

The IaaS 390 service may provide the end-user with the ability to provision processing, storage, networks, and other fundamental computing resources. The IaaS service includes a hardware layer 392 that is responsible for managing the physical resources available via the cloud-computing environment (e.g., cloud-computing environment 100). Specifically, the hardware layer 392 may include physical servers, routers, switches, power and cooling systems and may, according to one embodiment, be implemented using one or more data centers that incorporate many (e.g., hundreds, thousands, etc.) of interconnected servers, CPUs, mainframes, reduced instruction set computer (RISC), architecture based servers, blade servers, storage devices, network computing components, memory, disk, bandwidth, etc. organized through switches, routers, and/or other fabrics.

IaaS service 390 may also include an infrastructure layer (e.g., a virtualization layer) 394 that includes virtual machine capabilities and storage capabilities using computing resources that may be partitioned using various virtualization technologies (e.g., a hypervisor that runs directly on the system hardware (e.g., Xen), a kernel-based virtual machine (KVM), Hyper-V virtualization, VMware software, etc.). With IaaS service 390, the end-user may be able to deploy and run arbitrary software, which can include operating systems and applications, via the virtual machines. Although the end-user would not be authorized to manage or control the underlying cloud infrastructure, the end-user would be authorized to control operating systems, storage, deployed applications, and some limited network components (e.g., host firewalls).

According to one embodiment, the provider provides users with access to a SaaS service 370 using a computer system of a user device that can display, via a user interface of the user device, various information to perform various tasks. The user may also enable push notifications via the SaaS service 370 in order to receive a pop-up alert or other message even if the application associated with the SaaS service 370 is not open or in use. In some embodiments, the SaaS service 370 may be configured to allow users to provide, via a text box or other control input, contact information so that the user can receive an electronic notification through email, SMS text, or other electronic process.

Although various embodiments are described above, these are only examples. For example, computing environments of other architectures can be used to incorporate and use one or more embodiments.

According to various embodiments, a scannable image (e.g., a QR code, barcode, etc.) may include a machine-readable matrix code and may be generated by an entity to be included in print form along with an instrument that is produced to enables users to activate the instrument. In one example, the scannable image may be used to generate a partially populated form to activate a financial card (e.g., a debit card, a credit card, a gift card, etc.). The scannable image may be generated using a software available via a web portal that encodes data by embedding data modules within the scannable image. For example, a customer may sign up to receive a financial card from an entity and during production of the financial card a scannable image is generated that would be used to initiate activation of the financial card. Upon ascertaining that the scannable image has been scanned, encoded data from the scannable image will indicate user data and instrument data that would be needed to activate the card and a form is partially populated with information indicated by the encoded data. For example, the form may be partially populated with the financial card number that is represented by the instrument data and the name of the user that is associated with the user data. The form also includes input elements such as form fields where the user would need to provide additional information. For example, in order to activate the financial card, the user may be required to provide personally identifiable information such as their social security number, a security code, etc.

The scannable image may that is generated may be unique to each instrument that is produced. In some embodiments, the scannable image may be distributed separately from the instrument. For example, the entity may add an extra layer of security by sending the financial card to a user address of the user in one mail parcel and send the scannable image in another may parcel. In another embodiment, the scannable image may be distributed via an email, a SMS text message, a push notification, a fax, or other electronic communication method.

In one non-limiting example of a scannable image, a QR code may be used, which includes a two dimensional—2D barcode that forms a machine-readable matrix that can be read by 2D image sensors that are included in various optical instruments such as scanners and digital cameras. Notably, a QR code provides a level of security as data transfer is not subject to being human readable or easily copied by end-users without use of a computing device. A scannable QR code image allows for storage of various kinds of data and other information. In one embodiment, the amount of data stored to the QR code may depend on the resolution or number of pixels included within the QR code image. A digital camera may be used to capture an image of the QR code and may include integrated software module(s) that are configured to read the encoded data within the QR code image. Unlike one-dimensional bar codes, the QR code design allows characters to be stored in a format where the data is not identified by a single set of vertical black strips, and instead black dots may be arranged in a square-shaped grid against a white background so that data can be stored in patterns along both the horizontal and vertical direction of the square. The QR code may feature three distinctive squares at three corners of the square-shaped QR code image with another image in the fourth corner of the square-shaped QR code image. Data stored in the QR code image may be read by an imaging device and then a processing device interprets the image. In particular, the imaging device may detect an encoding region and function patterns, where the function patterns comprise finder patterns of the three corners of the QR code image as well as timing patterns. Separators may separate each finder pattern of the three corners from the rest of the QR code patterns or symbols. The finder patterns may include blocks of black modules of a particular dimension (e.g., 3×3 pixels or blocks) that are surrounded by a square of border of white modules that is one module thick, which may in turn be surrounded by another square border of block modules that is one module thick.

Further, QR codes may use Reed-Solomon error correction over a finite field of elements that are encoded as bytes of 8 bits. The number of data versus error correction bytes within each block depends on the version (side length) of the QR symbol and the error correction level. In general, there are four error correction levels and the higher the error correction level then the less storage capacity of the data. In larger QR code images, there may be several Reed-Solomon code blocks, and the size of the block may be selected in order to reduce the amount of errors per block to limit the complexity of the decoding algorithm. In addition, the code blocks may be interleaved together to make it less likely that localized damage to the QR symbol will overwhelm the capacity of any single block. Masking may be used to break up patterns in the data encoded in the QR code that might confuse a scanner or imaging device.

Example QR codes that may be utilized as part of scannable image 205 may include, without limitation, (i) models 1 and 2 QR codes, (ii) micro QR code for applications where symbol size is limited, (iii) secure QR codes (SQR codes) that include a private data segment instead of specified filler bytes where the private data segment must be deciphered with an encryption key, (iv) just another barcode (JAB) codes that are color 2D matrices made of color squares arranged in either a square or rectangle grid, (v) frame QR codes having a canvas area that can be flexibly used where graphics, letters, and other information can be flexibly arranged thereby making it possible to lay out the code without losing the design of illustrations, photos, and the like, and (vi) high capacity colored 2D that may utilize colors for increasing data density.

In some examples, the scannable image is printed on a physical medium (e.g., paper, a sticker, etc.). The physical medium can additional information about the instrument including, for example, terms and conditions and/or instructions for activating the instrument. In some embodiments, a user device (e.g., a mobile phone, a tablet, etc.) that includes an optical instrument (e.g., a camera, image sensor, etc.) is capable of scanning the scannable image printed on the physical medium. The user device also includes a speaker capable of playing audio that may provide instructions for guiding a user to fill out the form to activate the instrument. The user device also includes a user interface (e.g., a screen, GUI, etc.) that may display the partially populated form and enable the user to provide inputs for various input elements needed to activate the instrument. According to one embodiment, when the user selects a camera application available via the user device and the optical instrument may be used to scan the scannable image.

The scannable image may be detected when the optical instrument identifies a bounding region formed by and encompassing the QR code. Contemporaneously with detecting the bounding region that encompasses the QR code, pattern recognition is performed via an image sensor of the optical instrument on readable matrix code of the scannable image. This process deciphers the readable matrix code and identifies data modules embedded within the scannable image. The data modules include encoded data associated with the user and with the instrument.

In some embodiments, the partially populated form is generated within an augmented reality (AR) environment. The user device may utilize calculations and/or other algorithmic operations to dynamically produce the changing simulated environment in which user actions are used to control the environment through hand movements, head movements (looking up, down, left, and right), and user-positioning within the simulated environment. AR refers to the integration of digital information with the user's environment in real time. AR users experience a real-world environment with computer-generated perceptual information visually combined or overlaid on real world images. Example AR devices can include smart glasses (e.g., Apple Vision Pro® glasses, Xreal® AR glasses, etc.). A user can interact with the computer-generated simulation of a three-dimensional image or environment in a seemingly real or physical way by using, for example, a mobile phone, tablet, smart glasses, or other user device. AR does not typically greatly occlude the user's view of their real environment, which enables users to see the partially populated form within the context of their real environment. The AR version of the form may include characters combined with or overlaid in the background scene. Any number of artificial characters and/or objects can be included in the background scene.

Disclosed herein are improved systems and methods for encoding data to provide enhanced authentication and security to users. In some embodiments, the system generates, with a processor, a scannable image by encoding information about a user and about an instrument in pixel values across a dot profile such as a 2D symbol selected from the group consisting of a QR code, a micro QR code, a data matrix code, an Aztec code, a maxicode, a codablock F, a PDF417 code, and a PDF 417 truncated code. The scannable image may be printed and distributed to a specific user based on the user data encoded into the scannable image. The system may compare, with a processor on a pixel by pixel basis, each pixel of the scannable image to stored data to convert information derived from the scannable image to a partially populated form, where the partially populated form includes information about the instrument and the user.

In some embodiments, the system enhances existing computer authentication and security systems by providing multiple authentication approached. For example, when the user scans the image, a completely automated public turing test on the user device is generated and an input is received and compared to information displayed via the completely automated public turning test to verify that the user is human. The completely automated public turing test generates a random code that is visibly displayed on the user interface of the user device. Information is received from the user device and compared to the random code. Further, once the partially populated digital data submission form is displayed, one or more inputs that are provided for each of the input elements are compared to stored user data to verify the user's identity. Thus, the system compares obtained information with the completely automated public turing test data to authenticate that the user is human and also compares user inputs to user data and/or instrument data to authenticate the customer's information and instrument information to determine whether the instrument should be activated. This provides a layer of fraud prevention by providing multiple layers of authentication before proceeding with activation of the instrument. This specific combination provides significantly more than standard authentication procedures in that it includes reading data from a scannable image that was generated by the computing system in response to receipt of a request for the instrument. The encrypted code data is used by the processor to verify the instrument and the user in order to generate the partially populated form. This secure access procedure operates is a non-conventional and non-generic way to ensure that the user's identity is verified in a secure manner that is more than the conventional verification processes used to activate instruments.

In particular, the systems and methods disclosed herein set up a sequence of events that address unique problems associated with financial cards and card activation (e.g., by mitigating the activation of stolen bank cards by fraudulent actors to perform unauthorized transactions). Thus, the systems and methods disclosed herein set up a specific combination of discrete processes normally conducted when a user calls in to an enterprise to verbally authenticate their financial card and is required to say or enter a pin or provide some other form of authentication.

FIG. 3 depicts a block diagram of an example method 300, in accordance with an embodiment of the present invention. At block 305, the system receives a request to initiate production of an instrument having secure access control, the instrument being specific to a user, and based thereon the system encodes data associated with the instrument and the user as part of a scannable image to provide the access control of the instrument, wherein the data encoded as part of the scannable image are associated with partially populating a digital data submission form. In some embodiments, the instrument includes code data embedded within a magnetic stripe. The instrument may include, for example, a financial card that is inoperative until it has been activated using the method 300. In some embodiments, the magnetic stripe stores data by using magnetic recording technology that encodes the data on tiny iron particles. Specifically, the tiny iron particles may be magnetized, using a solenoid, in different directions so that when the magnetic stripe is swiped a voltage is introduced into the coils of a cardreader device that is connected to a processor to read the voltage introduced by the magnetized iron particles. The magnetic stripe may include various tracks with different information stored to each track. In some embodiments, the instrument includes information embedded within a near field communication chip. When the instrument is in close proximity to a terminal antenna, the antenna picks up signals of the near field communication chip and activates the near field communication chip. The near field communication chip then generates a one-time cryptographic code and sends the code along with various data to a terminal via electromagnetic waves. The terminal and instrument exchange encrypted information back and forth to complete the payment.

At block 310, the system initiates production and distribution of the instrument and the scannable image. In some embodiments, production of the scannable image includes arranging modules within a grid pattern. In some embodiments, the scannable image is a 2D symbol selected from the group consisting of a QR code, a micro QR code, a data matrix code, an Aztec code, a maxicode, a codablock F, a PDF417 code, and a PDF 417 truncated code.

At block 315, the system ascertains that the scannable image has been scanned by an image sensor of an optical instrument and based thereon transmit a version of the digital data submission form that is partially populated with user data associated with the user and instrument data associated with the instrument, the version of the digital data submission form including one or more input elements. In some embodiments, the system partially populates the version of the digital data submission form. In some embodiments, the method also includes initiating, upon ascertaining that the scannable image has been scanned by a user device, display of a completely automated public turing test on the user device. Further, the system may receive an indication that a response provided from the user device that is associated with the completely automated public turing test verified the user as being a human, wherein the transmitting of the version of the digital data submission form is further based on the indication. In some embodiments, the version of the digital data submission form is transmitted for display via an activation webpage of an entity, wherein the entity issues the instrument.

At block 320, the system receives one or more inputs for each of the input elements. In some embodiments, the one or more inputs include personally identifiable information of the user, wherein the verifying compares the personally identifiable information to stored personally identifiable information included in the user data. In some embodiments, the input elements include text fields for inputting at least one selected from the group consisting of a social security number, a date of birth, a card verification value, and a card number. At block 325, the system verifies that each of the one or more inputs correspond to the user data of the user. At block 330, the system authenticates, based on the one or more inputs corresponding to the user data, activation of the instrument for future use.

FIG. 4 depicts a block diagram of an example method 400, in accordance with an embodiment of the present invention. At block 405, the computing system of a user device scans via an image sensor of an optical instrument, a scannable image and based thereon detect modules within the scannable image, the modules encoding data associated with a user and an instrument. Once scanned, the device may display a completely automated public turing test. Further, the system may receive an indication that a response provided from the user device that is associated with the completely automated public turing test verified the user as being a human.

At block 410, the system displays, via a user interface, a partially populated digital submission form incorporating the data associated with the user and the instrument, wherein the partially populated digital submission form includes one or more input elements. At block 415, the system receives one or more inputs for each of the one or more input elements. At block 420, the system transmits a completed digital submission form for verification to facilitate activation of the instrument. In some embodiments, the system displays an indication that the completed digital submission form is verified and that the instrument is activated. In some embodiments, the scannable image is a 2D symbol selected from the group consisting of a QR code, a micro QR code, a data matrix code, an Aztec code, a maxicode, a codablock F, a PDF417 code, and a PDF 417 truncated code

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to explain the principles of one or more aspects of the invention and the practical application thereof, and to enable others of ordinary skill in the art to understand one or more aspects of the invention for various embodiments with various modifications as are suited to the particular use contemplated.

It is to be noted that various terms used herein such as “Linux®,” “Windows®,” “macOS®,” “iOS®,” “Android®,” and the like may be subject to trademark rights in various jurisdictions throughout the world and are used here only in reference to the products or services properly denominated by the marks to the extent that such trademark rights may exist.

What is claimed is:

1. A computing system for protection of data from malicious access by security and authentication through encoding, the computing system comprising:
at least one processor;
a communication interface communicatively coupled to the at least one processor; and
one or more memory devices storing executable code, wherein execution of the executable code causes the at least one processor to:
receive a request to initiate production of an instrument having secure access control, the instrument being specific to a user, and based thereon encode data associated with the instrument and the user as part of a scannable image to provide the access control of the instrument, wherein the data encoded as part of the scannable image are associated with partially populating a digital data submission form;
initiate production and distribution of the instrument and the scannable image;
ascertain that the scannable image has been scanned by an image sensor of an optical instrument and based thereon transmit a version of the digital data submission form that is partially populated with user data associated with the user and instrument data associated with the instrument, the version of the digital data submission form including one or more input elements;
receive one or more inputs for each of the input elements;
verify that each of the one or more inputs correspond to the user data of the user; and
authenticate, based on the one or more inputs corresponding to the user data, activation of the instrument for future use.

2. The system of claim 1, wherein execution of the executable code further causes the at least one processor to partially populate the version of the digital data submission form.

3. The system of claim 1, wherein execution of the executable code further causes the at least one processor to:
initiate, upon ascertaining that the scannable image has been scanned by a user device, display of a completely automated public turing test on the user device; and
receive an indication that a response provided from the user device that is associated with the completely automated public turing test verified the user as being a human, wherein the transmitting of the version of the digital data submission form is further based on the indication.

4. The system of claim 1, wherein the one or more inputs include personally identifiable information of the user, wherein the verifying compares the personally identifiable information to stored personally identifiable information included in the user data.

5. The system of claim 1, wherein the version of the digital data submission form is transmitted for display via an activation webpage of an entity, wherein the entity issues the instrument.

6. The system of claim 1, wherein production of the scannable image includes arranging modules within a grid pattern.

7. The system of claim 1, wherein the scannable image is a 2D symbol selected from the group consisting of a QR code, a micro QR code, a data matrix code, an Aztec code, a maxicode, a codablock F, a PDF417 code, and a PDF 417 truncated code.

8. The system of claim 1, wherein the input elements include text fields for inputting at least one selected from the group consisting of a social security number, a date of birth, a card verification value, and a card number.

9. The system of claim 1, wherein the instrument includes code data embedded within a magnetic stripe.

10. The system of claim 1, wherein the instrument includes information embedded within a near field communication chip.

11. A computer-implemented method, comprising:
receiving a request to initiate production of an instrument having secure access control, the instrument being specific to a user, and based thereon encoding data associated with the instrument and the user as part of a scannable image to provide the access control of the instrument, wherein the data encoded as part of the scannable image are associated with partially populating a digital data submission form;
initiating production and distribution of the instrument and the scannable image;
ascertaining that the scannable image has been scanned by an image sensor of an optical instrument and based thereon transmitting a version of the digital data submission form that is partially populated with user data associated with the user and instrument data associated with the instrument, the version of the digital data submission form including one or more input elements;
receiving one or more inputs for each of the input elements;
verifying that each of the one or more inputs correspond to the user data of the user; and
authenticating, based on the one or more inputs corresponding to the user data, activation of the instrument for future use.

12. The computer-implemented method of claim 11, further comprising partially populating the version of the digital data submission form.

13. The computer-implemented method of claim 11, further comprising:
initiating, upon ascertaining that the scannable image has been scanned by a user device, display of a completely automated public turing test on the user device; and
receiving an indication that a response provided from the user device that is associated with the completely automated public turing test verified the user as being a human, wherein the transmitting of the version of the digital data submission form is further based on the indication.

14. The computer-implemented method of claim 11, wherein the one or more inputs include personally identifiable information of the user, wherein the verifying compares the personally identifiable information to stored personally identifiable information included in the user data.

15. The computer-implemented method of claim 11, wherein the version of the digital data submission form is transmitted for display via an activation webpage of an entity, wherein the entity issues the instrument.

16. The computer-implemented method of claim 11, wherein the scannable image is a 2D symbol selected from the group consisting of a QR code, a micro QR code, a data matrix code, an Aztec code, a maxicode, a codablock F, a PDF417 code, and a PDF 417 truncated code.

17. A computing system, comprising:
at least one processor;
a communication interface communicatively coupled to the at least one processor; and
one or more memory devices storing executable code, wherein execution of the executable code causes the at least one processor to:
scan, via an image sensor of an optical instrument, a scannable image and based thereon detect modules within the scannable image, the modules encoding data associated with a user and an instrument;
display, via a user interface, a partially populated digital submission form incorporating the data associated with the user and the instrument, wherein the partially populated digital submission form includes one or more input elements;
receive one or more inputs for each of the one or more input elements; and
transmit a completed digital submission form for verification to facilitate activation of the instrument.

18. The computing system of claim 17, wherein execution of the executable code further causes the at least one processor to display an indication that the completed digital submission form is verified and that the instrument is activated.

19. The computing system of claim 17, wherein based on the scannable image being scanned execution of the executable code further causes the at least one processor to:
display a completely automated public turing test; and
receive an indication that a response provided from the user device that is associated with the completely automated public turing test verified the user as being a human.

20. The computing system of claim 17, wherein the scannable image is a 2D symbol selected from the group consisting of a QR code, a micro QR code, a data matrix code, an Aztec code, a maxicode, a codablock F, a PDF417 code, and a PDF 417 truncated code.
